(19) United States
(12) Patent Application Publication
(10) Pub. No.: US 2003/0093954 A1
(43) Pub. Date: May 22, 2003

(54) Apparatus for storing energy

(76) Inventors: Robin Willats, Preston (GB); John Emson, West Bromwich (GB); Sidney Fisher, Redditch (GB); Gurbinder Kalsi, Oldbury (GB); Nigel Spurr, Solihull (GB); Jean Didier, Anould (FR); Alan Dixon, Dodleston (GB); Stephen Drysdale, Northampton (GB)

Correspondence Address: CARLSON, GASKEY & OLDS, P.C., 400 WEST MAPLE ROAD, SUITE 350, BIRMINGHAM, MI, 48009, US

(21) Appl. No.: 10/300,160

(22) Filed: Nov. 20, 2002

(30) Foreign Application Priority Data
Nov. 21, 2001 (GB) GB 0127872.0

(51) Int. Cl. E05F 11/54

(52) U.S. Cl. 49/279; 49/502

(57) ABSTRACT

Apparatus for storing energy provided when a door is displaced so as to subsequently enable the energy thereby stored to be released to assist in the release of a pawl from a latch bolt of a latch mechanism, the apparatus comprising energy storage means and release means to selectively release the energy once stored.

This application claims priority to United Kingdom patent application number 0127872.0 filed on Nov. 21, 2002.

### BACKGROUND OF THE INVENTION

The present invention relates to apparatus for storing energy. More particularly, the present invention relates to apparatus for storing energy provided when a door is displaced and which is then capable of selectively releasing the energy at a later time.

Energy is required to unlatch latched vehicle doors. This energy is primarily required to overcome the frictional resistance between a latch bolt and pawl tooth of a latch mechanism when the pawl tooth retains the latch in a latched position. This resistance is largely induced by the force of seals around the door that normally tend to urge the door into an ajar position, but which when the door is latched, act between a striker mounted on the door surround and the latch bolt. This force is commonly known as the “seal force”.

Vehicle users demand ever reducing levels of noise in the passenger cabin of vehicles. To meet this demand, there has been a trend towards there being an ever closer fit between the vehicle doors and their seals, thus resulting in an increased seal force. In some instances, the seal force is approaching 1000N. In turn, this leads to an increased unlatching force being required to overcome the frictional resistance between the pawl tooth and latch bolt. In some circumstances, vehicle users may find it difficult to supply a sufficient unlatching force using a conventional unlatching mechanism in which exterior and interior handles are directly mechanically linked to the pawl.

When a vehicle suffers an impact, particularly from the side, deformation of the vehicle door may also result in an increased unlatching force being required.

### SUMMARY OF THE INVENTION

The present invention seeks to overcome, or at least mitigate, the aforesaid problems.

One aspect of the present invention provides an apparatus for storing energy provided when a door is displaced so as to subsequently enable the energy thereby stored to be released to assist in the release of a pawl from a latch bolt of a latch mechanism, the apparatus comprising energy storage means and release means to selectively release the energy once stored.

### BRIEF DESCRIPTION OF THE DRAWING

The present invention will now be described, by way of example only, with reference to the accompanying drawings in which:

FIG. 1 is a cross-sectional view on a horizontal plane of a vehicle door incorporating a mechanism according to one embodiment of the present invention;

FIGS. 1A to 1C are schematic views of a mechanism incorporating a door latch, and an energy storage apparatus according to one embodiment of the present invention in which energy is being stored with the door incorporating the mechanism latch in a closed and latched, closed and released, and an open and released position respectively (note: some components are not shown in their true plane for ease of explanation);

FIGS. 2A to 2C are views in direction A of FIGS. 1A to 1C respectively showing release means of the apparatus;

FIGS. 3A to 3C are schematic views of energy storage apparatus according to another embodiment of the present invention in positions corresponding to the device of the first embodiment;

FIGS. 4A to 4C are views in direction B of FIGS. 3A to 3C respectively of release means according to another embodiment of the present invention;

### DESCRIPTION OF THE PREFERRED EMBODIMENT

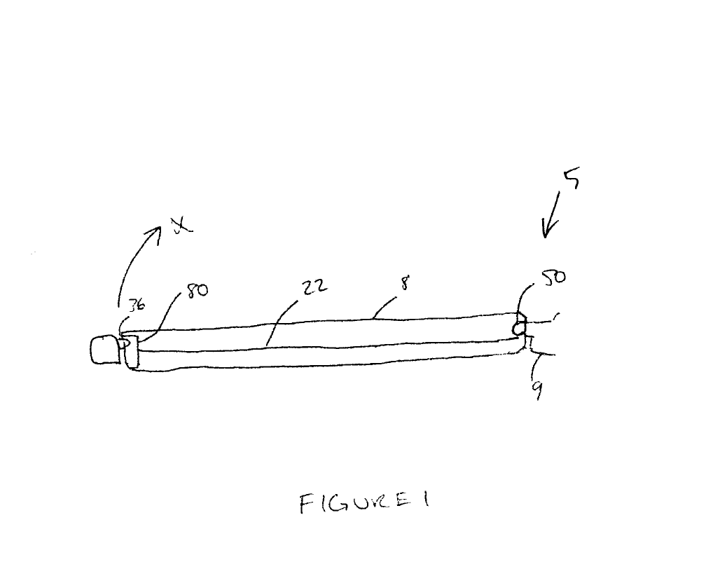

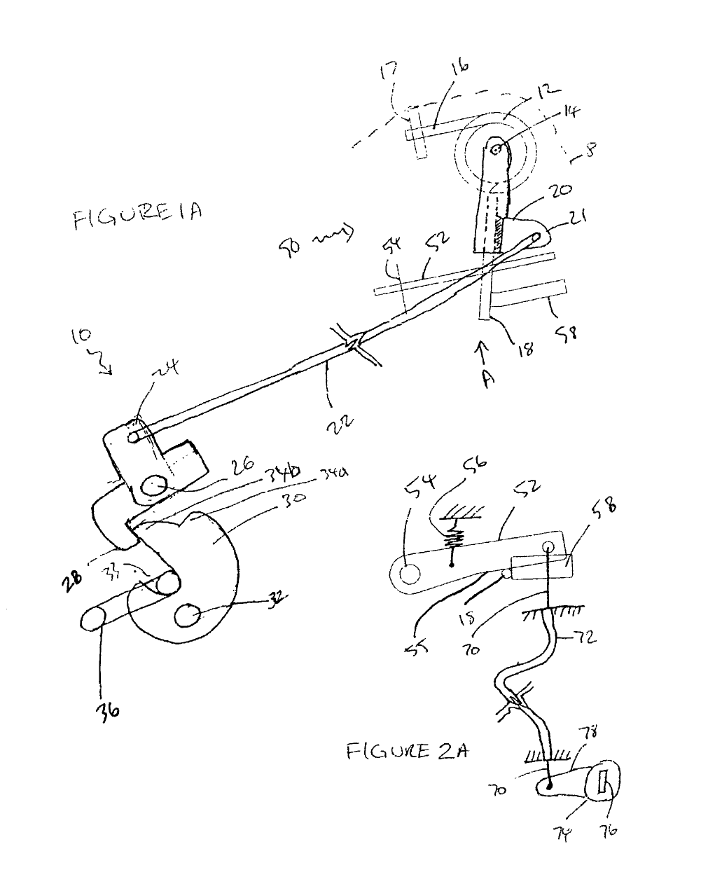

Referring to FIGS. 1 and 1A, the mechanism 10 comprises an apparatus 50 having a helically wound torsion spring 12 mounted substantially coaxially with hinge pin 14 of a door hinge (not shown) for pivotally mounting a door 8 to a vehicle 5. As shown, the door 8 is arranged to open in a clockwise direction X. In this embodiment, the door 8 is a side passenger door, but the apparatus may also be employed on any other hinged closure, such as a rear hatchback, estate or boot-type door or lid.

One leg 16 of spring 12 is secured to a portion 17 of the door. An arm 20 pivotal about substantially the same axis as hinge pin 14 is arranged so as to abut a second leg 18 of the spring 12 throughout the arc of movement of the leg 18 so as to cause the loading and unloading of the spring when deflected from a rest position. However, the leg 18 may rotate clockwise independent of the arm 20. The radially outermost end 21 of the arm 20 has pivotally mounted thereon an elongate linkage member 22, the member 22 being further pivotally mounted at its opposite end to a pawl 24 of latch mechanism 80.

The pawl is rotatably mounted about pivot 26 to a fixed portion of the door 8, such as a mounting plate (not shown) of the latch mechanism 80. The pawl 24 comprises a pawl tooth 28 arranged so as to retain a claw-type latch bolt 30. Claw 30 is rotatable about pivot 32 and is provided with a mouth region 33 which in a released position (shown in FIG. 1B) receives a striker pin 36 and during closing of the door is caused to rotate to the position shown to FIG. 1A, as is known. First and second notches 34a and 34b provided on the periphery of the claw 30 provide first safety and fully closed positions that may be engaged by the pawl tooth 28 of pawl 24 to maintain the claw in its latched condition. Pawl 24 is preferably biased into contact with the periphery of claw 30 by resilient means such as a spring (not shown).

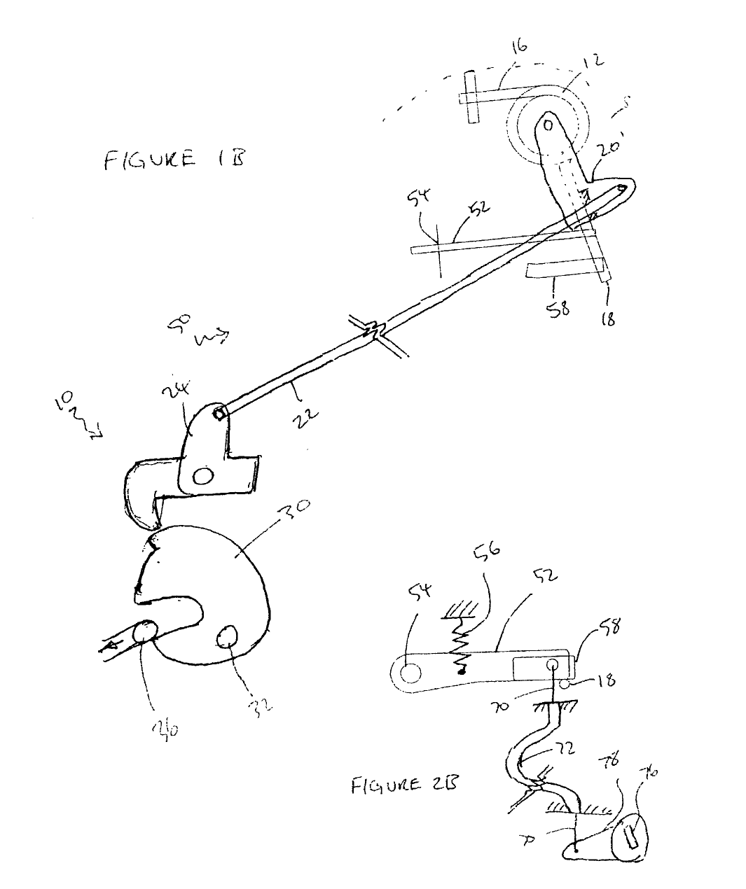

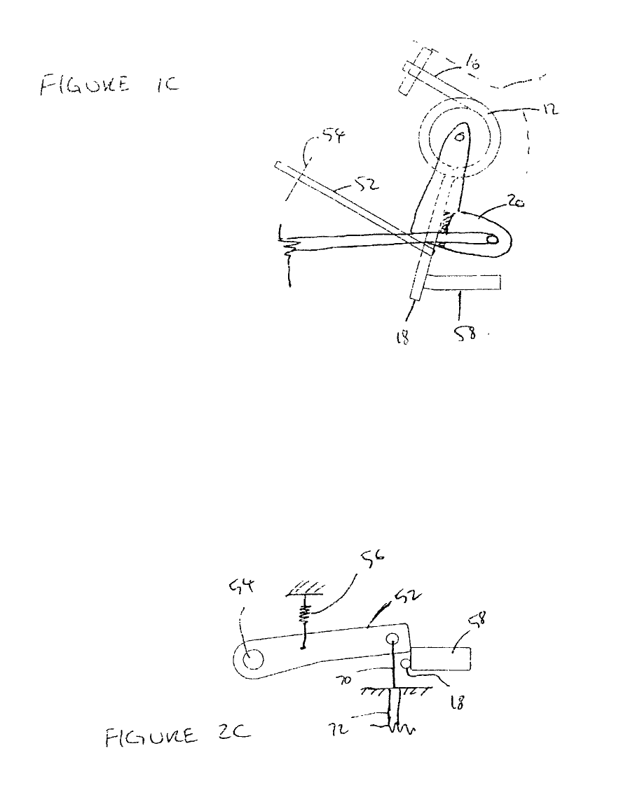

Turning now to FIG. 2A, the release means of the apparatus 50 is shown schematically. In this embodiment, the release means comprises a release arm 52 rotatable about pivot 54 that is mounted on a fixed portion of the door such as door surround 9. The lower edge 55 of the arm is arranged so as to slidably abut leg 18 of the spring 12. The arm is biased into a retracted position by resilient means which in this embodiment comprises a helical tension spring 56. As can be seen from FIG. 2A, the spring 12 is loaded due to leg 18 being rotated in a clockwise direction by a projection 58 mounted to a fixed part of the vehicle such as the door surround 9. As well as being capable of resilient deflection in the conventional clockwise and anti-clockwise directions, leg 18 is also resiliently deformable vertically when viewed in FIG. 2A. However, the no load position in this plane is the position of leg 18 shown in FIG. 2A.

The release means is further provided with a flexible Bowden cable comprising a cable 70 slidably mounted within a sheath 72. The cable 70 is pivotally secured at one end to arm 52 and that the other to an actuating arm 78 of a key operated release mechanism positioned remotely from the apparatus 50. The release mechanism comprises a key barrel 74, into which an appropriate key 76 is inserted and may be rotated, causing the actuating arm 78 to rotate correspondingly.

When a vehicle user wishes to release the latch using the release means described, turning a key in lock 76 causes arm 52 to pivot clockwise against the biasing of spring 56, thus causing leg 18 to be dislodged from projection 58, as can be seen from FIG. 2B. This releases the stored energy from the spring 12, thereby causing pawl tooth 28 to be disengaged from the claw 30. This in turn permits the claw to rotate and release the striker, thereby enabling the door 8 to be opened as shown in FIG. 1C.

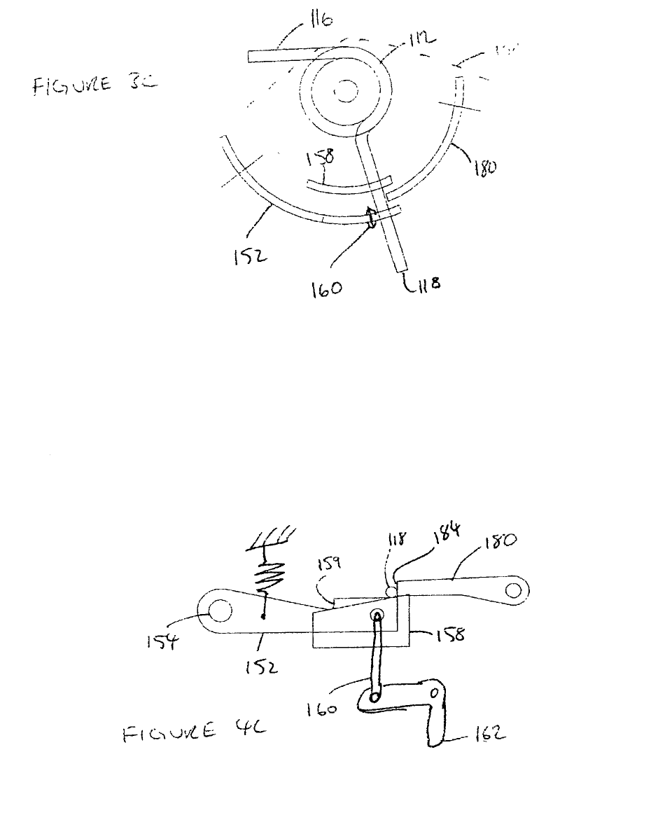

The release means of this embodiment is intended to be used infrequently such as when an alternative remote door opening means has not been used, and would then only be operated by the vehicle user when the vehicle has a flat battery or by emergency personnel if the normal means malfunctions in an emergency, for example. However, this arrangement may be replaced by a connection to the inside and/or outside door handle as in the second embodiment (see FIG. 4A).

To reset the apparatus, the door 8 must first be opened to at least the position of FIG. 1C. This enables leg 18 to return to its vertical rest position (see FIG. 2C). Closure of the door causes leg 18 to abut projection 58. As the door is closed, the first leg 16 (which is secured to the door) rotates about the axis of hinge pin 14 against the resilience of the spring 12. This brings leg 18 closer to leg 16 and thereby loading spring 12 and storing a proportion of the kinetic energy supplied by closing the door. Because the door is essentially being used as a lever having a substantial length, a significant amount of energy may be stored by the spring 12 without there being an appreciable increase in the effort required to close the door.

During the closure process, leg 18 remains in abutment with projection 58, thereby storing the energy provided until a later time. This movement of leg 18 further simultaneously permits elongate link member 22 to move from right to left in response to the biasing of pawl 24 into contact with claw 30, thereby enabling pawl tooth 28 to engage behind one or other of notches 34A and 34B when contact between striker pin 36 and mouth 33 of the claw causes the claw to rotate clockwise as the door is shut. The freedom of arm 20 to move anticlockwise prevents tooth 28 fouling on the periphery of claw 30 whilst the door is being closed. The mechanism is now back in the state illustrated in FIGS. 1A and 2A. It can be seen that in the position of FIG. 2A, leg 18 is in contact with the lower face 55 of arm 52.

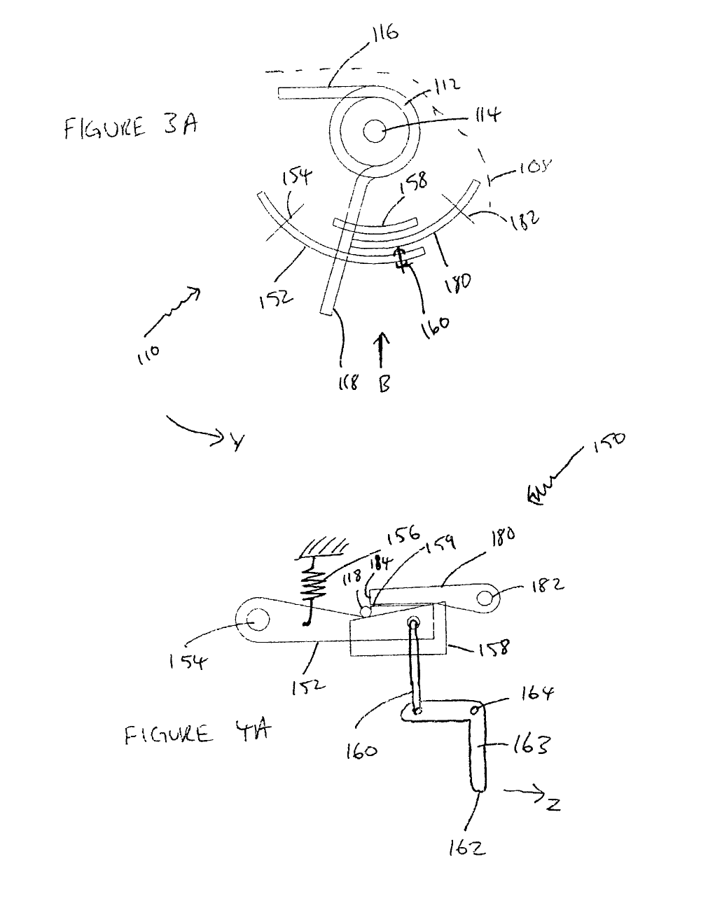

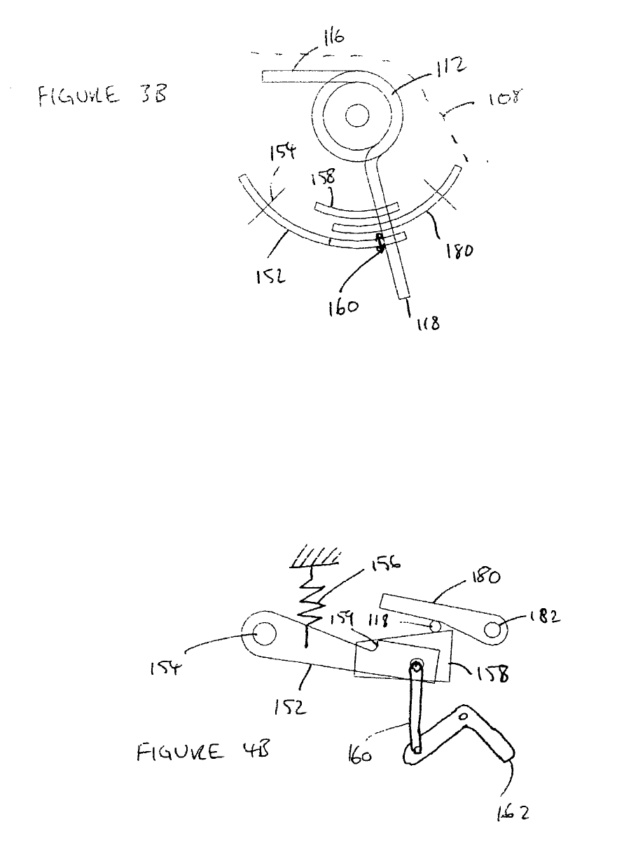

Turning now to FIGS. 3A to 4C, an alternative embodiment of the present invention is shown. Where possible, like numerals have been used for like parts with the addition of the prefix “1”. In the drawings, arm 20, linkage 22, pawl 24 and claw 30 are omitted since these are identical to those shown in the figures of the first embodiment. In this embodiment, the door 108 is hung from a hinge pin 114 and is arranged to open in an anti-clockwise direction Y.

Referring in particular to FIG. 4A, the release means 150 of the apparatus 110 comprises a release arm 152 rotatable about a pivot 154 that is mounted to a fixed point on the vehicle. A catch 159 remote from pivot 154 is arranged so as to releasably retain spring leg 118. In this embodiment, the arm is biased into a deployed position by resilient means comprising a helical tension spring 156. Linkage member 160 pivotally interconnects arm 152 with a remotely positioned L-shaped release handle 162 arranged to be rotatable about a pivot 164 such that pulling on an engagement portion 163 of the handle in a direction Z causes arm 152 to pivot in an anti-clockwise direction.

The release means further comprises a ramp member 158 that is secured to the vehicle and a setting lever 180 which is rotatably secured about pivot 182 to the door 108. The setting lever 180 has a face 184 remote from pivot 182 and is arranged to engage spring leg 118 when the mechanism is being reset.

Referring to FIGS. 3A and 4A, leg 118 (which is at its vertical rest position) is released by pulling on handle 162 thus releasing the leg from its position within the catch 159. This causes the leg to move in an anti-clockwise direction and rise up the ramp 158 whilst simultaneously causing setting lever 180 to pivot in a clockwise direction as can be seen most clearly from FIG. 4B. As in the first embodiment, the release spring 118 provides the energy to release the pawl tooth from the claw, thereby enabling the door 108 to be opened.

Thereafter, the mechanism can only be reset once the door 108 has been opened by at least predetermined amount shown in FIGS. 3C and 4C. In this position, setting arm 180 has returned to its rest position with engagement face 184 in contact with leg 118. Thus, as the door 108 is reclosed, the setting lever causes the spring 112 to be loaded up to the point which leg 118 is recaptured by catch 159.

In one class of embodiment, handle 162 is the conventional outside or inside door release handle and the apparatus 110 operates each time the door is unlatched in order to provide additional energy to release the latch mechanism when there is a consistently high seal load acting on the door. However, in alternative embodiments, the apparatus may only be operated in abnormally high seal load conditions, such as after an impact has occurred which deforms the door and increases the frictional load between pawl tooth 28 and notch 34a or 34b.

In such embodiments, pawl 24 is also connected to a conventional unlatching mechanism as well as the apparatus of the present invention, and handle 62 may be provided in a secure position either on the inside of the vehicle or in a locked compartment such as a boot or bonnet or behind a fuel filler flap where it could be accessed in emergency situations by the vehicle user or emergency personnel, for example.

In a preferred embodiment, the apparatus is provided as a self-contained unit.

It should be understood that numerous changes may be made within the scope of the present invention. For example, alternative means for storing energy could be provided. For example, different types of spring such as compression, extension, gas or watch-type springs. Closing the door could generate electrical energy by using a dynamo/magneto or a piezoelectric cell, with the electric energy stored in a rechargeable battery or capacitor. An electrical switch provided within an electrical circuit connected to the battery could then act as the release means. Additionally, energy can be stored by lifting a mass within the door. It should be appreciated that energy could be stored by opening rather than, or in addition to, the closing of the door and that the door need not be opened or closed by its full amount for the energy to be stored. The apparatus may assist in the latching of the latch mechanism as well as, or as an alternative to assisting in unlatching.

1. Apparatus for storing energy provided when a door is displaced so as to subsequently enable the energy thereby stored to be released to assist in the release of a pawl from a latch bolt of a latch mechanism, the apparatus comprising energy storage means and release means to selectively release the energy once stored.

2. Apparatus according to claim I wherein the apparatus further assists in the latching of the latch mechanism.

3. Apparatus according to claim 1 wherein the door is a vehicle door.

4. Apparatus according to claim 3 wherein the energy is stored by the closing of the door.

5. Apparatus according to claim 3 wherein the energy is stored by opening the door.

6. Apparatus according to claim 3 wherein the door is pivotally hung by a hinge.

7. Apparatus according to claim 1 wherein the energy storage means is resilient means.

8. Apparatus according to claim 7 wherein the resilient means is a torsion spring.

9. Apparatus according to claim 8 wherein the door is pivotally hung by a hinge, said hinge defines a hinge pivot axis and the torsion spring is arranged substantially coaxial therewith.

10. Apparatus according to claim 1 wherein the release means comprises a catch mechanism.

11. Apparatus according to claim 10 wherein the the release means is a torsion spring and the catch mechanism is arranged so as to releasably retain a spring leg of the torsion spring.

12. Apparatus according to claim 10 wherein the catch mechanism is operably interconnectable to a door release handle for the door.

13. Apparatus according to claim 9 wherein the catch mechanism is operably interconnectable to a key operated release mechanism.

14. Apparatus according to claim 1 wherein the storage means is a rechargable battery.

15. Apparatus according to claim 14 wherein a dynamo or magneto or piezoelectric device converts the energy provided by displacement of the door into electrical energy for storage in the battery.

16. Apparatus according to claim 1 wherein the release means is an electrical switch.

17. Apparatus according to claim 16 wherein the switch is provided within an electrical circuit connected to the energy storage means.

18. Apparatus according to claim 17 wherein an electrical actuator is further connected to the electrical circuit and is arranged so as to operate the latch.

19. Apparatus according to claim 1 provided as a self contained unit.

20. A door assembly including an apparatus for storing energy provided when a door is displaced so as to subsequently enable the energy thereby stored to be released to assist in the release of a pawl from a latch bolt of a latch mechanism, the apparatus comprising energy storage means and release means to selectively release the energy once stored.
